(19) United States
(12) Patent Application Publication
(10) Pub. No.: US 2006/0168854 A1
(43) Pub. Date: Aug. 3, 2006

(54) 2-N-1 light box with built-in L.E.D.

(76) Inventor: Mitchell Sitcov, Palm City, FL (US)

Correspondence Address: JOSEPH S. BECKMAN, 3104 SW WIMBELDON TERRACE, PALM CITY, FL, 34990, US

(21) Appl. No.: 11/048,664

(22) Filed: Jan. 29, 2005

(51) Int. Cl. G09F 13/04

(52) U.S. Cl. 40/564

(57) ABSTRACT

A self-contained, multiple message display system for the improved display of advertisements containing both a fixed media viewing space and a LED message display or its equivalent.

### FIELD OF THE INVENTION

This invention relates to the design and construction of a novel single-unit, multiple message display system for the improved display of advertisements.

### BACKGROUND OF THE INVENTION

Light boxes and LED displays for advertising exist in various forms and are well known in the prior art. Conventionally and ubiquitously, advertising displays have used pre-printed, fixed media that only allow one message to be displayed at a given time, particularly wherein the display contains a lighting means to illuminate the fixed media. As the development of the prior art has progressed, there have been numerous displays developed that incorporate multiple messages in a single display. For example, such displays include rotating display screens that change to allow different messages to be displayed. The drawback to this type of invention is that it is limited to non-changeable, pre-printed messages that are fixed on the display system.

Electronic displays, including light emitting diode (LED) displays, liquid crystal displays (LCD), and plasma displays overcame the afore-mentioned fixed display drawback by allowing variable messages to be displayed. The messages are typically programmed using a processing unit connected to the display. The messages are then scrolled, swiped or flashed across the electronic display. While electronic displays allow variable messages to be displayed, they do not allow for the constant display of the message. This is a distinct drawback of variable, electronic message displays given that no advertising message will appear if the display unit is not programmed to display the message, or if transmission errors occur. When no variable, electronic advertising message is being displayed it could mean substantial lost revenue for the advertiser.

There is prior art that has utilized a shared display system to allow a fixed message to be displayed when a variable electronic message is not being displayed. Shared displays are advantageous over displays that only utilize a fixed display or a variable display because a message will be constantly displayed if a variable electronic message is not in use on the shared display. However, a shared display can only display one message at a time. The fixed, print message, which typically includes an eye-catching graphic to initially attract consumer attention to the advertisement, is lost when a variable, electronic message is being scrolled, swiped, or flashed across the shared display screen. This is a distinct disadvantage of the shared display systems because when a fixed message is constantly displayed it attracts the consumer's attention and entices the consumer to read additional information provided in the variable message, such as special point-of-purchase offers related to the advertised product or service.

Prior art disclosed in U.S. Pat. No. 5,132,666 issued to Fahs entitled “Vehicle-mounted electronic display system,” attempts to address the use of both a fixed and variable message display. However, the Fahs display system is specifically designed to mount atop a vehicle and the fixed and variable displays mounted atop thereto. This type of system does not contemplate traditional advertising mediums wherein a single-unit, slim, easily moveable, poster-like display unit is needed to advertise products or services. Moreover, the programming means utilized to change the variable message are mounted to a vehicle's dashboard to allow only the driver to program the message for its specific vehicle. The disadvantage here is that the message cannot be remotely programmed and multiple vehicles with display units cannot be networked to allow all units to be easily programmed together. If a fleet of vehicles were to be programmed to run the same advertisement, a person would have to separately go into each vehicle and program each vehicle display unit with the same message.

Clearly there is a need for a single unit advertising display system, which allows both a fixed message and a variable electronic message to be display simultaneously while being capable of remote programming and networking of single or multiple display units for use in traditional advertising mediums.

### SUMMARY OF THE INVENTION

There have been a number of light boxes and LED displays in the prior art. The inventive structure presents a number of advantages over the prior art. First, the invention is simple to form. The display system comprises a single frame that may be formed in variable dimensions to incorporate different frame designs, including portrait and landscape design layouts. The frame contains both a fixed media viewing space and a LED message display. It should be noted that equivalent display structures such as LCD and plasma displays may be utilized and substituted wherever a reference to an LED message display is made herein. In the preferred embodiment, the fixed media viewing space utilizes the majority of the frame space to create a more dynamic display that will attract consumer attention. The frame support provides a fixed media viewing space capable of supporting advertising media of various thicknesses to allow adaptability when changing the display to include a new advertisement. The frame also includes backlighting or side-lighting means such as bulbs or other light-emitting devices to illuminate the fixed media viewing space. In the preferred embodiment, the fixed media viewing space is illuminated through the use of fluorescent tubes.

The LED display portion of the display system may be programmed in multiple language character sets. The LED may incorporate multiple display methods including the ability to swipe, scroll, and flash a desired message. The LED also may incorporate multiple font options, display speeds, and multi-color pixel options including high-brightness for exterior (outdoor) use or application and monochrome color options.

The proposed invention provides the advantage of portability and the convenience of remote control and remote programming. The proposed invention may be powered on and off via a remote control. Remote facilities may be utilized to program the LED message display. The display units may also be networked, singularly or in large groups providing an easy way to engage in one way or two-way communications with each display unit. This network communication may be used to update the LED message in a single display or multiple displays at one time, communicate problems with a single or multiple displays requiring attention and/or repair or communicate data regarding consumer initiated communication with the display unit for monitoring and charting geographic and demographic trends in response to advertisements.

The proposed invention may further incorporate a communication means, such as wired, wireless, cellular, blue tooth, infrared GPS or equivalent technologies to receive communications from the advertiser for dynamic message editing or operation. This function may be particularly useful where the display unit is located on the advertiser's premises or located a short distance from the premises. For instance, a merchant in a shopping center may utilize the proposed invention on the mall premises to direct traffic to the merchant's store. The merchant may utilize the communication means to dynamically promote special sales and point-of-advertising incentives to encourage shoppers to visit the store by remotely updating the display through the communication or network means. The proposed invention may further utilize communication means to accept requests for information and respond to said requests by transmitting pre-programmed information to the requesting party. For instance, the fixed media advertisement or LED display may display a code or sequence of alphanumeric symbols which may be transmitted over short range communication devices by an interested consumer to access a menu, to be displayed on the LED display, for further product information. The proposed invention may similarly utilize these communication means to invite an interested consumer to request that further product information be delivered to the consumer's preferred device or contact account, such as a traditional telephone answering machine, an email account or for immediate display on a cellular telephone or other portable electronic device. In this manner, the advertisement encourages interaction and involvement by interested consumers at the point-of-contact and greatest potential sales interest.

Lastly, the single-unit display is slim, easily movable, and is designed to function in traditional advertising mediums more effectively than the prior art.

### BRIEF DESCRIPTION OF THE DRAWINGS

FIG. 1 is a view of a landscape oriented display unit incorporating a fixed media viewing space and LED message display.

FIG. 1A is a side view of said landscape oriented display unit of FIG. 1.

FIG. 1B is a bottom view of said landscape oriented display unit of FIG. 1.

FIG. 1C is a three dimensional rendering of said landscape oriented display unit of FIG. 1.

FIG. 2 is a view of a portrait oriented display unit incorporating a fixed media viewing space and LED message display.

FIG. 2A is a side view of said portrait oriented display unit of FIG. 2.

FIG. 2B is a bottom view of said portrait oriented display unit of FIG. 2.

FIG. 2C is a three dimensional rendering of said landscape oriented display unit of FIG. 2.

FIG. 3 is a view of the LED message display.

FIG. 3A is a side view of the LED message display.

FIG. 3B is a bottom view of the LED message display.

FIG. 3C is a three dimensional rendering of said landscape oriented display unit of FIG. 3. FIG. 4 is a schematic illustrating the relationship between the lighting, communication, and programming means of the display unit of FIG. 1 and FIG. 2.

### DESCRIPTION OF THE INVENTION

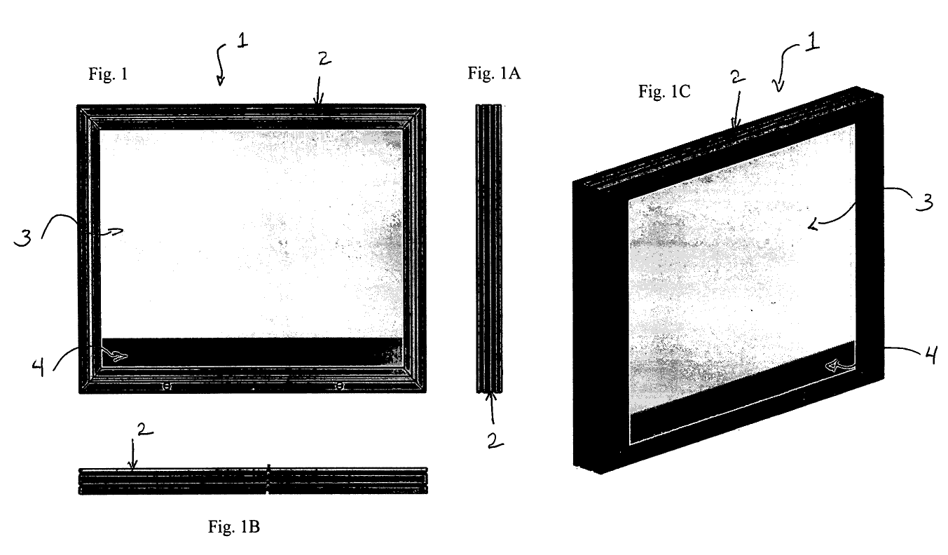

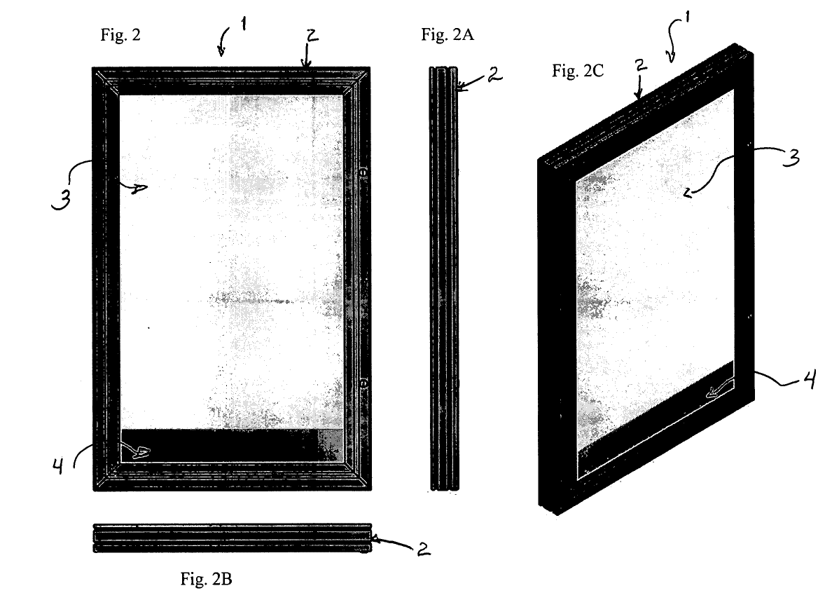

Shown in FIG. 1 and FIG. 2 is a display unit (1) comprising a frame (2) a fixed media viewing space (3) and LED message display (4).

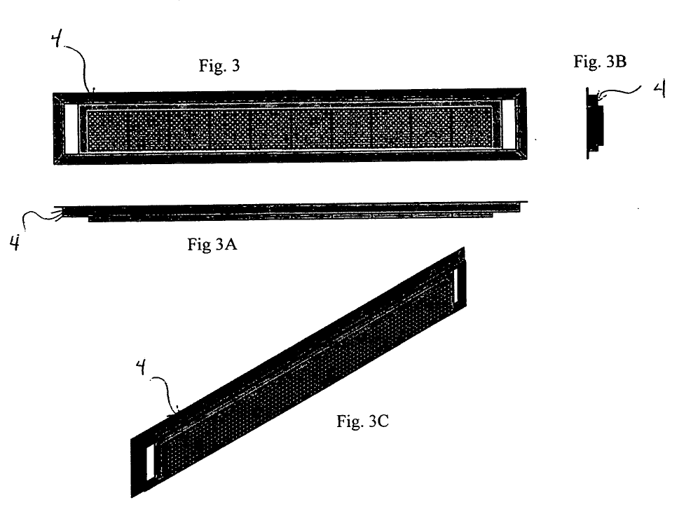

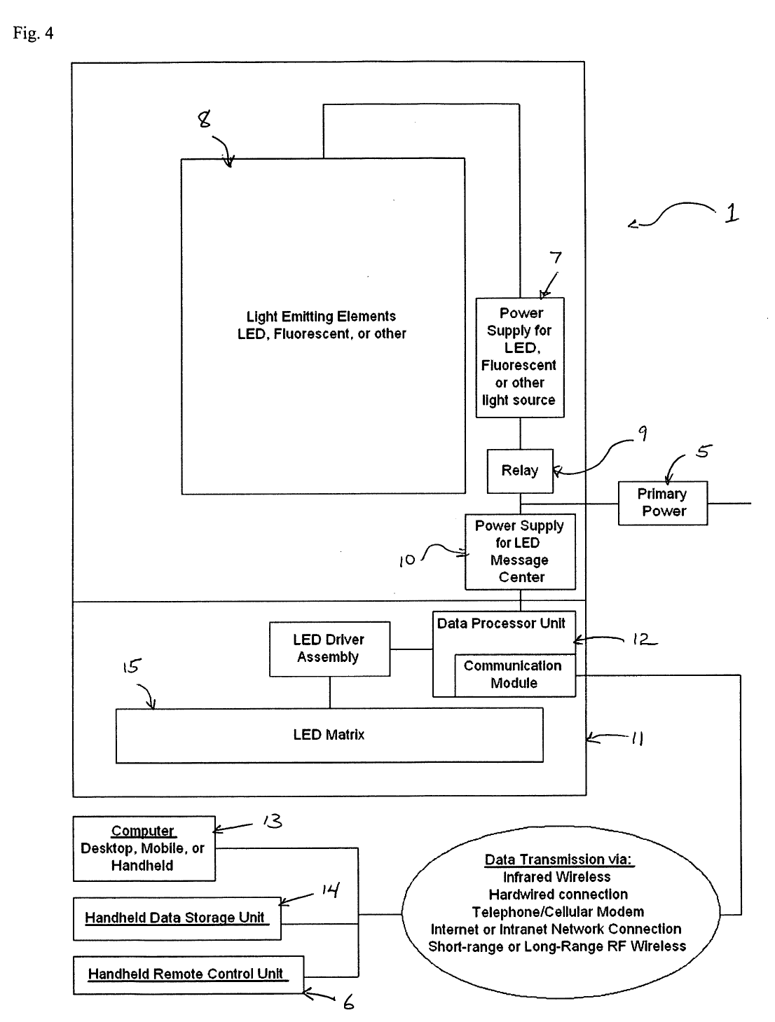

Referring now to FIG. 3 is the LED message display (4), which is secured into the frame (2) of the display unit (1).

Shown in FIG. 4 is schematic of the lighting, communication, and programming means of the display unit (1). The display unit (1) is powered by a primary power source (5) which is capable of being powered on and off by a handheld remote control unit (6).

A power supply (7) delivers power to the light emitting elements (8). The light emitting elements (8) are utilized to illuminate the advertisement appearing behind the fixed media viewing space (4). A relay (9) connects the power supply (7) for the light emitting elements (8) and the power supply (10) for the LED message display (11). The LED message display (11) contains a date processing unit with a communication module (12), which may communicate data with a computer (13), handheld data storage unit (14) and/or a handheld remote control unit (6). The data is then displayed on the LED matrix (15). Although the invention has been described with regard to certain preferred embodiments which constitute the best mode presently known to the inventor, it should be understood that changes and modifications that would be obvious to one having the ordinary skill in this art may be made without deviating from the scope of the invention.

What is claimed is:

1. A single-unit, multiple message display unit for the improved display of advertisements, said unit comprising:
A single frame;
Said frame containing both a fixed media viewing space and a LED message display, and;
Said frame containing lighting means capable of illuminating said fixed media viewing space from the side or behind.

2. A single-unit, multiple message display unit as described in claim 1 capable of being remotely powered into on and off states of display.

3. A single-unit, multiple message display unit as described in claim 1 with receiver means to remotely program the LED message.

4. A single-unit, multiple message display unit as described in claim 1 and further comprising network capabilities that may network multiple single-unit, multiple message display units together.

5. A single-unit, multiple message display unit as described in claim 1 wherein said single frame is about 26.5″ wide and about 42.5″ high and about 3″ deep and wherein said fixed media viewing space is about 23″ wide and about 35″ high.

6. A single-unit, multiple message display unit as described in claim 1 wherein said single frame is about 38.5″ wide and about 31.75″ high and about 3″ deep and wherein said fixed media viewing space is about 35″ wide and about 23″ high.

7. A single-unit, multiple message display unit as described in claim 1 wherein said fixed media viewing space contains support means to allow advertising media up to ⅛″ thick.

8. A single-unit, multiple message display unit as described in claim 1 wherein said lighting means consist of Four 30 watt T8 fluorescent tubes 36″ in length.

9. A single-unit, multiple message display unit as described in claim 1 wherein said LED display is capable of being programmed in English and European character sets.

10. A single-unit, multiple message display unit as described in claim 1 wherein said LED display is capable of swipe, scroll and flash display methods.

11. A single-unit, multiple message display unit as described in claim 1 wherein said LED display has seven font options.

12. A single-unit, multiple message display unit as described in claim 1 wherein said LED display has eight display speeds.

13. A single-unit, multiple message display unit as described in claim 1 wherein said LED display has red, green, and amber pixel options.

14. A single-unit, multiple message display unit as described in claim 1 wherein said single frame has green, blue, yellow, orange, or white monochrome color options.

15. A single-unit, multiple message display unit as described in claim 1 further comprising a communication means for short range communication to a cell phone or other personal electronic device.

16. A single-unit, multiple message display unit as described in claim 1 further comprising a communication means for wireless communication of pre-programmed messages upon request.
